(19) United States
(12) Patent Application Publication
(10) Pub. No.: US 2014/0178739 A1
(43) Pub. Date: Jun. 26, 2014

(54) POSITIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventor: Tae-Jin Jung, Yongin-si (KR)

(73) Assignee: SAMSUNG SDI CO., LTD., Yongin-si (KR)

(21) Appl. No.: 13/830,204

(22) Filed: Mar. 14, 2013

(30) Foreign Application Priority Data
Dec. 21, 2012 (KR) 10-2012-0151258

(51) Int. Cl. H01M 4/485; H01M 4/525; H01M 4/505

(52) U.S. Cl. CPC H01M 4/485; H01M 4/505; H01M 4/525
USPC 429/144; 429/223; 429/341; 429/188; 423/594.4; 252/182.1

(57) ABSTRACT

Disclosed is a positive electrode for a rechargeable lithium battery that includes a positive active material including lithium-nickel cobalt manganese composite metal oxide, wherein the positive active material has an increase rate of a specific surface area of from about 66.4% to about 77.5% after pressing relative to a specific surface area of the positive active material before pressing, and the positive electrode has an active mass density of from about 2.514 g/cc to about 3.389 g/cc.

### INCORPORATION BY REFERENCE TO RELATED APPLICATIONS

Any and all priority claims identified in the Application Data Sheet, or any correction thereto, are hereby incorporated by reference under 37 CFR 1.57.

This application claims priority to and the benefit of Korean Patent Application No. 10-2012-0151258 filed in the Korean Intellectual Property Office on Dec. 21, 2012, the entire contents of which are incorporated herein by reference.

### BACKGROUND

1. Field

This disclosure relates to a positive electrode for a rechargeable lithium battery and a rechargeable lithium battery including the same.

2. Description of the Related Technology

A rechargeable lithium battery has recently drawn attention as a power source for a small portable electronic device. The rechargeable lithium battery uses an organic electrolyte solution and thereby, has twice or more of the discharge voltage of a conventional battery using an alkali aqueous solution and resultantly, has high energy density.

As for positive active materials for a rechargeable lithium battery, lithium-transition element composite oxides being capable of intercalating lithium such as LiCoO₂, LiMn₂O₄, LiNi₁₋ₓCoₓO₂ (0<x<1), and so on have been researched. As for negative active materials for a rechargeable lithium battery, various carbon-based materials such as artificial graphite, natural graphite, and hard carbon capable of intercalating and deintercalating lithium ions have been used.

Currently, much research on increasing energy density of a rechargeable lithium battery has been made to accomplish high-capacity thereof. In particular, an attempt to increase energy density by using an Si-based oxide or a Sn-based oxide, an alloy thereof, and the like known to have high capacity as a negative active material have been paid attention to. However, these negative active materials have a problem of very big initial irreversible capacity.

Conventionally, a Li₂MoO₃ material is mixed with a positive active material in order to compensate initial irreversible capacity caused by the negative active material. However, since the Li₂MoO₃ material has an unstable structure, other elements are added thereto to improve stability but still do not secure sufficient stability and have a problem of Mo dissolution and the like when a charge and discharge cycle is repeated. Accordingly, research on improving cycle-life characteristics of a lithium rechargeable battery has been still made.

### SUMMARY

One embodiment provides a positive electrode for a rechargeable lithium battery being capable of improving cycle-life characteristics of a rechargeable lithium battery.

Another embodiment provides a rechargeable lithium battery having improved cycle-life characteristics.

According to one embodiment, provided is a positive electrode for a rechargeable lithium battery that includes a positive active material comprising lithium-nickel cobalt manganese composite metal oxide, wherein the positive active material has an increase rate of from about 66.4% to about 77.5% of a specific surface area after pressing relative to a specific surface area of the positive active material before pressing, and the positive electrode has an active mass density of from about 2.514 g/cc to about 3.389 g/cc.

According to another embodiment, a negative electrode including a negative active material; a positive electrode including a positive active material including lithium-nickel cobalt manganese composite metal oxide; a separator interposed between the negative and positive electrodes; and an electrolyte, wherein the positive active material has an increase rate of from about 66.4% to about 77.5% of a specific surface area after pressing relative to a specific surface area of the positive active material before pressing, and the positive electrode has an active mass density of from about 2.514 g/cc to about 3.389 g/cc.

The lithium-nickel cobalt manganese composite metal oxide may be represented by the following Chemical Formula 1.

LiₐNiₓCO_{y}Mn_{z}MₖO₂ Chemical Formula 1

In Chemical Formula 1,

M is selected from Al, Mg, Ti, Zr, and a combination thereof,

0.95≦a≦1.10, 0.45≦x≦0.65, 0.15≦y≦0.25, 0.15<z≦0.35, 0≦k≦0.1, and x+y+z+k=1.

The positive electrode may have an increase rate of from about 9.8% to about 17% of a specific surface area after pressing relative to a specific surface area before pressing.

The negative active material may be selected from a material that reversibly intercalates/deintercalates lithium ions, a lithium metal, a lithium metal alloy, a material being capable of doping lithium, and a transition metal oxide.

The electrolyte may include a non-aqueous organic solvent selected from carbonate-based, ester-based, ether-based, ketone-based, alcohol-based, and aprotic solvents.

The electrolyte may include a lithium salt of from about 0.1 M to about 2.0M.

The separator may have air permeability of from about 170 sec/100 cc to about 380 sec/100 cc.

Other embodiments are described in the detailed description.

Accordingly, the present embodiments provide a positive electrode for a rechargeable lithium battery being capable of improving cycle-life characteristics and a rechargeable lithium battery including the same.

### BRIEF DESCRIPTION OF THE DRAWINGS

FIG. 1 is a schematic view showing a rechargeable lithium battery according to one embodiment.

FIG. 2 is a graph showing cycle-life characteristics of rechargeable lithium battery cells according to Examples 1 to 3 and Comparative Examples 1 and 2.

FIG. 3 is a graph showing cycle-life characteristics of rechargeable lithium battery cells according to Examples 1 and 7.

### DETAILED DESCRIPTION

Example embodiments of this disclosure will hereinafter be described in detail. However, these embodiments are only examples, and this disclosure is not limited thereto.

A positive electrode for a rechargeable lithium battery according to one embodiment includes a positive active material including lithium-nickel cobalt manganese composite metal oxide, wherein the positive active material has an increase rate of from about 66.4% to about 77.5% of a specific surface area after pressing relative to a specific surface area of the positive active material before pressing, and the positive electrode has an active mass density of from about 2.514 g/cc to about 3.389 g/cc.

The lithium-nickel cobalt manganese composite metal oxide may be represented by the following Chemical Formula 1.

LiₐNiₓCo_{y}Mn_{z}MₖO₂ Chemical Formula 1

In Chemical Formula 1,

M is selected from Al, Mg, Ti, Zr, and a combination thereof,

0.95≦a≦1.10, 0.45≦x≦0.65, 0.15≦y≦0.25, 0.15<z≦0.35, 0≦k≦0.1, and x+y+z+k=1.

The positive active material may be prepared by using a sulfate-based compound such as NiSO₄, CoSO₄, MnSO₄, and the like as a precursor compound of Ni, Co, and Mn, co-precipitating it to obtain a mixed metal hydroxide ((Ni₁₋ₓCo_{1-y}Mn_{1-z})OH)₂, and then, mixing the mixed metal hydroxide precursor and a Li precursor compound and firing the mixture.

The lithium-nickel cobalt manganese composite metal oxide may be a compound with the coating layer on the surface or a mixture of the lithium-nickel cobalt manganese composite metal oxide and a compound with the coating layer thereon. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any conventional processes unless it causes any side effects on the properties of the positive active material (e.g., spray coating, immersing), which is well known to those who have ordinary skill in this art and will not be illustrated in detail.

The positive active material may have an increase rate of from about 66.4% to about 77.5%, and for example, from about 66.4% to about 73.5% of a specific surface area after pressing relative to a specific surface area of the positive active material before pressing an increase rate of a specific surface area after pressing. Within the range of the increase rate of a specific surface area, cycle-life characteristics may be improved.

The positive active material has a smaller increase rate of a specific surface area, as the positive active material has additional strength. In addition, the positive electrode has a lower active mass density, as the positive active material has a smaller increase rate of a specific surface area before and after pressing.

The active mass density denotes electrode density after pressing a electrode with a predetermined pressure. In general, when a positive electrode has high active mass density, a positive active material exists more on a substrate under the same volume. According to one embodiment, a positive electrode has mass density ranging from about 2.514 g/cc to about 3.389 g/cc. According to another embodiment, a positive electrode has mass density ranging from about 2.834 g/cc to about 3/389 g/cc/ The positive electrode having active mass density within the range may improve cycle-life characteristics.

A rechargeable lithium battery according to another embodiment includes a negative electrode including a negative active material; a positive electrode including a positive active material including lithium-nickel cobalt manganese composite metal oxide; a separator interposed between the negative electrode and positive electrode; and an electrolyte, wherein the positive active material has an increase rate of from about 66.4% to about 77.5% of a specific surface area after pressing relative to a specific surface area of the positive active material before pressing, and the positive electrode has an active mass density of from about 2.514 g/cc to about 3.389 g/cc.

The rechargeable lithium battery has excellent cycle-life characteristics and particularly, cycle-life characteristics at a high temperature of from about 45° C.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, coin-type, or pouch-type batteries, and may be thin film batteries or may be rather bulky in size. The structure and the manufacturing method of these batteries are well known in a related field and will not be described in detail.

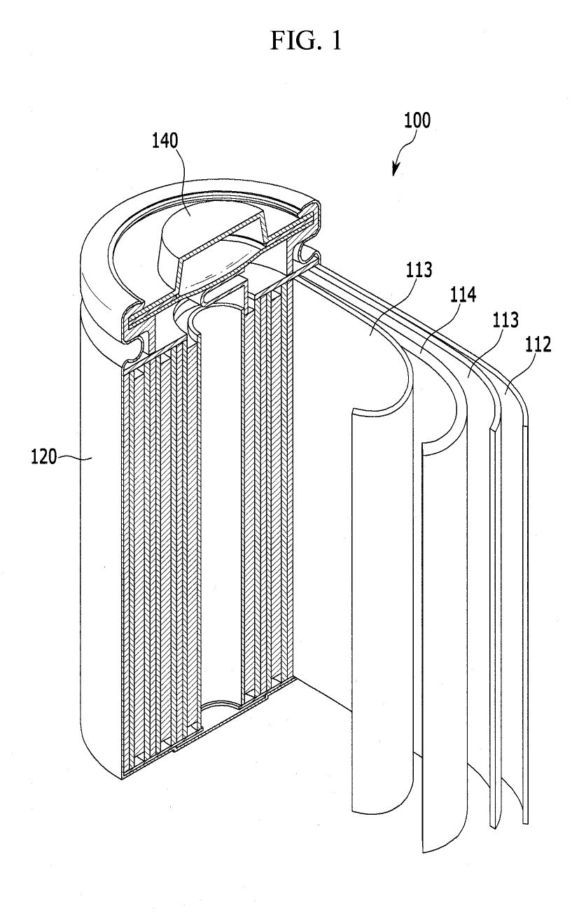

FIG. 1 is an exploded perspective view showing a rechargeable lithium battery in accordance with an embodiment. Referring to FIG. 1, the rechargeable lithium battery 100 is formed with a cylindrical shape and includes a negative electrode 112, a positive electrode 114, a separator 113 disposed between the a positive electrode 114 and negative electrode 112, an electrolyte (not shown) impregnated in the negative electrode 112, the positive electrode 114, and the separator 113, a battery case 120, and sealing member 140 sealing the battery case 120. The rechargeable lithium battery 100 is fabricated by sequentially stacking a negative electrode 112, separator 113, and a positive electrode 114, and spiral-winding them and housing the wound product in the battery case 120.

The negative electrode 112 includes a current collector and a negative active material layer formed on the current collector, and the negative active material layer includes the negative active material.

The negative active material includes one selected from a material that reversibly intercalates/deintercalates lithium ions, a lithium metal, a lithium metal alloy, a material being capable of doping and dedoping lithium, and a transition metal oxide.

The material that reversibly intercalates/deintercalates lithium ions includes carbon materials. The carbon material may be any generally-used carbon-based negative active material in a lithium ion rechargeable battery. Examples of the carbon material include crystalline carbon, amorphous carbon, and a combination thereof The crystalline carbon may be non-shaped, or sheet, flake, spherical, or fiber shaped natural graphite or artificial graphite. The amorphous carbon may be a soft carbon, a hard carbon, a mesophase pitch carbonized product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, or Sn.

Examples of the material being capable of doping and dedoping lithium include Si, SiOₓ (0<x<2), a Si-Q alloy (wherein Q is an alkali metal, an alkaline-earth metal, Group 13 to 16 elements, a transition element, a rare earth element, or a combination thereof, and not Si), Sn, SnO₂, a Sn—R alloy (wherein R is an alkali metal, an alkaline-earth metal, Group 13 to 16 elements, a transition element, a rare earth element, or a combination thereof and is not Sn), and the like. At least one of the foregoing materials may be mixed with SiO₂. The Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The transition element oxide may be vanadium oxide, lithium vanadium oxide, and the like.

The negative active material layer may include and optionally a conductive material.

The binder improves binding properties of the negative active material particles to one another and to a current collector. Examples of the binder include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material can be used as a conductive agent, unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be a copper foil, a nickel foil, a stainless steel foil, a titanium foil, a nickel foam, a copper foam, a polymer substrate coated with a conductive metal, or combinations thereof.

The positive electrode 114 includes a current collector and a positive active material layer disposed on the current collector.

The current collector may be Al, but is not limited thereto.

The positive active material layer includes a lithium-nickel-cobalt composite metal oxide which is the same as described above. The positive active material layer may include a binder and a conductive material.

The binder improves binding properties of the positive active material particles to one another and to a current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material may be used as a conductive agent, unless it causes a chemical change. For example, it may include natural graphite, artificial graphite, carbon black, acetylene black, ketjen black, carbon fiber, metal powder, metal fiber or the like such as copper, nickel, aluminum, silver or the like, or one or at least one kind of mixture of conductive material such as polyphenylene derivative or the like.

The negative electrode 112 and positive electrode 114 may be manufactured in a method of mixing the active material, a conductive material, and a binder with an active material composition and coating the composition on a current collector, respectively. The electrode-manufacturing method is well known and thus, is not described in detail in the present specification. The solvent may include N-methylpyrrolidone but is not limited thereto.

The separator 113 may include polyethylene, polypropylene, polyvinylidene fluoride, or a multilayer of two or more layers thereof, and it may also include a mixed multilayer such as a polyethylene/polypropylene 2-layered separator, a polyethylene/polypropylene/polyethylene 3-layered separator, a polypropylene/polyethylene/polypropylene 3-layered separator, or the like.

The separator may have air permeability ranging from about 170 sec/100 cc to about 380 sec/100 cc. The separator having air permeability within the range may provide a rechargeable lithium battery having excellent cycle-life characteristic.

The separator transmits lithium ions between positive and negative electrodes during the charge and discharge of the rechargeable lithium battery. The charging and discharging of the rechargeable lithium battery are occurred by these lithium ions so that the acts of the separator is critical. In general, a separator having small air permeability has good mobility of lithium ions, which improves battery performance (cycle-life). Accordingly, the smaller air permeability the separator has within the range, the better cycle-life characteristic it may bring about.

The electrolyte may be a non-aqueous electrolyte including a non-aqueous organic solvent and a lithium salt.

The non-aqueous organic solvent plays a role of transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, dimethylacetate, methylpropinonate, ethylpropinonate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran and the like, and the ketone-based solvent may include cyclohexanone, and the like. The alcohol-based solvent may include ethanol, isopropyl alcohol, and the like. The aprotic solvent include nitriles such as R—CN (wherein R is a C₂ to C₂₀ linear, branched, or cyclic hydrocarbon group, and may include a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, its mixture ratio may be controlled in accordance with desirable performance of a battery.

The carbonate-based solvent may include a mixture of a cyclic carbonate and a linear carbonate. The cyclic carbonate and the linear carbonate are mixed together in a volume ratio of from about 1:1 to about 1:9, which may enhance performance of an electrolyte.

In addition, the non-aqueous organic solvent may be prepared by further adding the aromatic hydrocarbon-based organic solvent to the carbonate-based solvent. The carbonate-based solvent and the aromatic hydrocarbon-based organic solvent are mixed together in a volume ratio of from about 1:1 to about 30:1.

The aromatic hydrocarbon-based organic solvent may be an aromatic hydrocarbon-based compound represented by the following Chemical Formula 2.

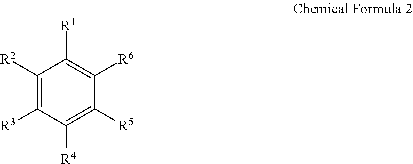

In Chemical Formula 2,

R¹ to R⁶ are independently selected from hydrogen, halogen, a C₁ to C₁₀ alkyl group, a C1 to C 10 haloalkyl group, and a combination thereof.

The aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3 -trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate or an ethylene carbonate-based compound represented by the following Chemical Formula 3 in order to improve cycle-life of a battery.

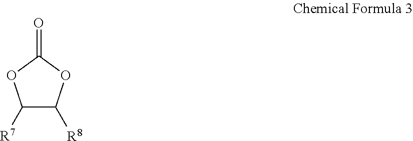

In Chemical Formula 3,

R⁷ and R⁸ are independently hydrogen, a halogen, a cyano group (CN), a nitro group (NO₂), or a C₁ to C₅ fluoroalkyl group, provided that at least one of R₇ and R₈ is a halogen, a cyano group (CN), a nitro group (NO₂), or a C₁ to C₅ fluoroalkyl group.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the vinylene carbonate or the ethylene carbonate-based compound may be adjusted within an appropriate range.

The lithium salt is dissolved in the non-aqueous solvent and supplies lithium ions in a rechargeable lithium battery, and basically operates the rechargeable lithium battery and improves lithium ion transfer between positive and negative electrodes. The lithium salt include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato) borate, LiBOB), and a combination thereof. The lithium salt may be used in a concentration of from about 0.1 M to about 2.0M. When the lithium salt is included within the above concentration range, it may electrolyte performance and lithium ion mobility due to optimal electrolyte conductivity and viscosity.

Hereinafter, the embodiments are illustrated in more detail with reference to examples. These examples, however, should not in any sense be interpreted as limiting the scope of the present embodiments.

Manufacture of Rechargeable lithium battery cell

### EXAMPLES 1 TO 6 AND COMPARATIVE EXAMPLES 1 and 2

A positive active material slurry was prepared by mixing 96 wt % of LiNi_{0.5}Co_{0.2}Mn_{0.3}O₂ having an increase rate of a specific surface area in the following Table 1 as a positive active material, 2 wt % of polyvinylidene fluoride as a binder, and 2 wt % of acetylene black as a conductive material and dispersing the mixture in N-methyl-2-pyrrolidone. The positive active material slurry was coated on a 15 μm-thick aluminum foil and then, dried at 160° C. for greater than or equal to 3 hours and pressed, fabricating a positive electrode. Herein, the positive electrode had the active mass density provided in Table 1 by adjusting pressing strength.

A negative active material slurry was prepared by mixing 97.5 wt % of graphite as a negative active material, 1.5 wt % of polyvinylidene fluoride as a binder, and 1 wt % of acetylene black as a conductive material and dispersing the mixture in water. The negative active material slurry was coated on a 8 μm-thick copper foil and then, dried at 140° C. for 3 hours and pressed, fabricating a negative electrode.

In addition, a non-aqueous electrolyte was prepared by uniformly mixing 70 volume % of dimethyl carbonate and 30 volume % of ethylene carbonate and dissolving 1.0M of LiPF₆ in the mixed solvent.

The negative and positive electrodes and a polyethylene separator having air permeability of 230 sec/100 cc were spirally-wound and pressed and then, put in a 18650 cell case, and the electrolyte solution was respectively injected therein, fabricating rechargeable lithium battery cells according to Examples 1 to 6 and Comparative Examples 1 and 2.

### EXAMPLE 7

A rechargeable lithium battery cell was fabricated according to the same method as Example 1 except for using a polyethylene separator having air permeability of 170 sec/100 cc instead of the polyethylene separator having air permeability of 230 sec/100 cc.

### EXAMPLE 8

A rechargeable lithium battery cell was fabricated according to the same method as Example 1 except for using a polyethylene separator having air permeability of 250 sec/100 cc instead of the polyethylene separator having air permeability of 230 sec/100 cc.

### EXAMPLE 9

A rechargeable lithium battery cell was fabricated according to the same method as Example 1 except for using a polyethylene separator having air permeability of 300 sec/100 cc instead of the polyethylene separator having air permeability of 230 sec/100 cc.

### EXAMPLE 10

A rechargeable lithium battery cell was fabricated according to the same method as Example 1 except for using a polyethylene separator having air permeability of 330 sec/100 cc instead of the polyethylene separator having air permeability of 230 sec/100 cc.

### Specific Surface Area and Increase Rate of Specific Surface Area of Positive Active Material Before and After Pressing

The specific surface area of the positive active materials before and after pressing was measured as follows. First of all, 3g of the positive active materials used in rechargeable lithium battery cells according to Examples 1 to 6 and Comparative Examples 1 and 2 were respectively put in a vial, heated at 250° C. for 3 hours, and pressed with a specific surface area measurement device and then, measured regarding specific surface area before pressing. The specific surface area of the positive active materials after pressing were measured according to the same method as the aforementioned measurement of the specific surface area before pressing by measuring the positive active materials by 3g and pressing them with 2.5 ton for 30 seconds using an oil-hydraulic 4350.L (CARVER Inc.). The specific surface areas before and after the pressing were used to calculate an increase rate of the specific surface area according to the following equation 1.

[(Specific surface area of a positive active material after pressing−specific surface area of a positive active material before pressing)/specific surface area of a positive active material before pressing]×100 Equation 1

### Pellet Density of Positive Active Material

The positive active materials were measured regarding pellet density as follows. The positive active materials used in each rechargeable lithium battery cell according to Examples 1 to 6 and Comparative Examples 1 and 2 were measured by 3 g and pressed with 2.5 ton for 30 seconds using an oil-hydraulic 4350.L (CARVER Inc.). Then, each positive active material pellet obtained from the aforementioned treatment was measured regarding length using a pair of vernier callipers (MITUTOYO Co.). The measurements were inserted in the equation 2 to calculate density of each pellet. The results are provided in the following Table 1.

Positive active material weight/[1.272×(holder length measured by a pair of vernier callipers−0.95)×0.1] Equation 2

### Specific Surface Area and Increase Rate of Specific Surface Area of Positive Electrode Before and After Pressing

The specific surface area and the increase rate of the specific surface area of the positive electrodes were measured as follows. The rechargeable lithium battery cells according to Examples 1 to 6 and Comparative Examples 1 and 2 were charged at 0.8C/4.2V with 110 mA under a condition of constant current/constant voltage, paused for 24 hours, and discharged at 1C/3V under a constant current, which was repeated 100 times. Then, the rechargeable lithium battery cells were decomposed to obtain the positive active materials therein. The positive active materials were measured regarding specific surface area and the increase rate of the specific surface area. Herein, the specific surface area and the increase rate of the specific surface area were measured according to the same method as performed for the aforementioned positive active material.

TABLE 1

| | | | | | | | Comparative | Comparative |
|---|---|---|---|---|---|---|---|---|
| | Example 1 | Example 2 | Example 3 | Example 4 | Example 5 | Example 6 | Example 2 | Example 1 |
| Specific surface | 0.134 | 0.191 | 0.152 | 0.282 | 0.234 | 0.323 | 0.367 | 0.101 |
| area of positive | | | | | | | | |
| active material | | | | | | | | |
| before pressing | | | | | | | | |
| (m²/g) | | | | | | | | |
| Specific surface | 0.223 | 0.328 | 0.263 | 0.491 | 0.410 | 0.573 | 0.661 | 0.163 |
| area of a positive | | | | | | | | |
| active material | | | | | | | | |
| after pressing | | | | | | | | |
| (m²/g) | | | | | | | | |
| Increase rate of a | 66.4 | 71.7 | 73.0 | 74.1 | 75.2 | 77.4 | 80.1 | 61.4 |
| specific surface | | | | | | | | |
| area of positive | | | | | | | | |
| active material | | | | | | | | |
| (%) | | | | | | | | |
| Pellet density of | 2.907 | 2.971 | 3.054 | 3.097 | 3.161 | 3.207 | 3.293 | 2.861 |
| positive active | | | | | | | | |
| material | | | | | | | | |
| (g/cc) | | | | | | | | |
| Specific surface | 0.843 | 0.923 | 0.891 | 0.989 | 0.964 | 1.013 | 1.081 | 0.816 |
| area of a positive | | | | | | | | |
| electrode before | | | | | | | | |
| pressing (m²/g) | | | | | | | | |
| Specific surface | 0.926 | 1.019 | 0.994 | 1.129 | 1.113 | 1.182 | 1.279 | 0.892 |
| area of a positive | | | | | | | | |
| electrode after | | | | | | | | |
| pressing (m²/g) | | | | | | | | |
| Increase rate of | 9.8 | 10.4 | 11.6 | 14.2 | 15.5 | 16.7 | 18.3 | 9.3 |
| specific surface | | | | | | | | |
| area of positive | | | | | | | | |
| electrode (%) | | | | | | | | |
| Active mass | 2.514 | 2.834 | 2.956 | 3.003 | 3.071 | 3.162 | 3.389 | 2.257 |
| density (g/cc) | | | | | | | | |

The positive active materials had a smaller increase rate of a specific surface area, as they had more strength. Referring to Table 1, the particle strength of the positive active materials turned out to change active mass density of positive electrodes under the same conditions.

In general, pellet density is obtained by applying the same pressure for the same mass of active materials. The higher density a pellet refers that the volume of the active materials decreases, after pressing (referring to Equation 2). Such a decrease in the volume indicates that the positive active materials in the pellet have various specific surface areas, even though the weight of the active materials are same before and after pressing. The possibility for entering in the holes between the active materials increases and thus a volume becomes smaller. In other words, it refers to a decrease in the pellet density (a proportion relationship between pellet density and specific surface area).

### Cycle-Life Measurement of Rechargeable Lithium Battery Cell Depending on Increase Rate of Specific Surface Area and Active Mass Density of Positive Active Material Before and After Pressing

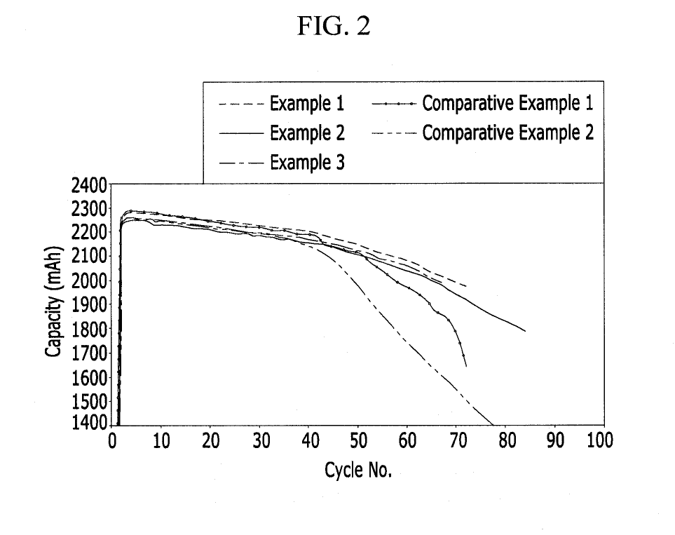

The rechargeable lithium battery cells according to Examples 1 to 6 and Comparative Examples 1 and 2 were charged at 45° C. with nominal capacity of 2200 mAh at 110 mA under a constant current/constant voltage of 0.8C/4.2V, paused for 24 hours, and discharged with 1C/3V under a constant current discharge, which was repeated 100 times. Then, the rechargeable lithium battery cells were measured regarding cycle-life characteristics. The results of the rechargeable lithium battery cells according to Examples 1 to 3 and Comparative Examples 1 and 2 were provided in FIG. 2.

FIG. 2 is a graph showing cycle-life characteristics of rechargeable lithium battery cells depending on increase rates of specific surface areas of positive active materials before and after pressing and active mass densities of positive electrodes according to Examples 1 to 3, Comparative Example 1, and Comparative Example 2.

As shown in FIG. 2, the rechargeable lithium battery cells having the increase rate of the specific surface area of the positive active materials after the pressing relative to that of the positive active materials before the pressing and active mass density of the positive active materials within the ranges of the embodiments according to Examples 1 to 3 had improved cycle-life characteristics compared with the ones according to Comparative Examples 1 and 2.

### Evaluation 3; Cycle-Life Measurement of Rechargeable Lithium Battery Cell Depending on Air Permeability of Separator

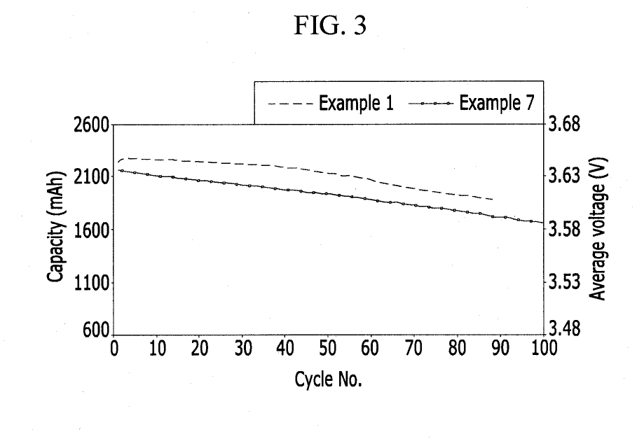

The rechargeable lithium battery cells according to Example 1 and Examples 7 to 9 were charged at 45° C. with nominal capacity of 2200 mAh at 110 mA under a constant current/constant voltage of 0.8C/4.2V, paused for 24 hours, and discharged at a constant current of 1C with 3V, which were repeated 100 times. The rechargeable lithium battery cells were measured regarding cycle-life characteristics. The results of the rechargeable lithium battery cells according to Examples 1 and 7 were provided in FIG. 3.

FIG. 3 is a graph showing capacity depending on cycles in order to measure cycle-life characteristics of rechargeable lithium battery cells according to Examples 1 and 7.

As shown in FIG. 3, the rechargeable lithium battery cells had better cycle-life characteristic as air permeability became larger in a range of 170 to 330 sec/100 cc.

While this disclosure has been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims.

What is claimed is:

1. A positive electrode for a rechargeable lithium battery, comprising
a positive active material comprising lithium-nickel cobalt manganese composite metal oxide, wherein the positive active material has an increase rate of from about 66.4% to about 77.5% of a specific surface area after pressing relative to a specific surface area of the positive active material before pressing, and wherein the positive electrode has an active mass density of from about 2.514 g/cc to about 3.389 g/cc.

2. The positive electrode of claim 1, wherein the lithium-nickel cobalt manganese composite metal oxide is represented by the following Chemical Formula 1:
LiₐNiₓCo_{y}Mn_{z}MₖO₂ [Chemical Formula 1]
wherein,
M is selected from Al, Mg, Ti, Zr, and a combination thereof, 0.95≦a≦1.10, 0.45≦x≦0.65, 0.15≦y≦0.25, 0.15<z≦0.35, 0≦k≦0.1, and x+y+z+k=1.

3. The positive electrode of claim 1, wherein the positive active material has an increase rate of from about 66.4% to about 73.5% of a specific surface area after pressing relative to a specific surface area of the positive active material before pressing.

4. The positive electrode of claim 1, wherein the positive electrode has an increase rate of from about 9.8% to about 17% of a specific surface area after pressing relative to a specific surface area before pressing.

5. A rechargeable lithium battery, comprising
a negative electrode including a negative active material;
a positive electrode including a positive active material including lithium-nickel cobalt manganese composite metal oxide;
a separator interposed between the negative electrode and positive electrode; and
an electrolyte,
wherein the positive active material has an increase rate of from about 66.4% to about 77.5% of a specific surface area after pressing relative to a specific surface area of the positive active material before pressing, and
wherein the positive electrode has an active mass density of from about 2.514 g/cc to about 3.389 g/cc.

6. The rechargeable lithium battery of claim 5, wherein the lithium-nickel cobalt manganese composite metal oxide is represented by the following Chemical Formula 1:
LiₐNiₓCo_{y}Mn_{z}MₖO₂ [Chemical Formula 1]
wherein,
M is selected from Al, Mg, Ti, Zr, and a combination thereof,
0.95≦a≦1.10, 0.45≦x≦0.65, 0.15≦y≦0.25, 0.15<z≦0.35, 0≦k≦0.1, and x+y+z+k=1.

7. The rechargeable lithium battery of claim 5, wherein the positive electrode the positive active material has an increase rate of from about 66.4% to about 73.5% of a specific surface area after pressing relative to a specific surface area of the positive active material before pressing.

8. The rechargeable lithium battery of claim 5, wherein the positive electrode has an increase rate of from about 9.8% to about 17% of a specific surface area after pressing of about relative to a specific surface area before pressing.

9. The rechargeable lithium battery of claim 5, wherein the negative active material is selected from a material that reversibly intercalates/deintercalates lithium ions, a lithium metal, a lithium metal alloy, a material being capable of doping lithium, and a transition metal oxide.

10. The rechargeable lithium battery of claim 5, wherein the electrolyte comprises a non-aqueous organic solvent selected from a carbonate-based solvent, ester-based solvent, ether-based solvent, ketone-based solvent, alcohol-based solvent, and aprotic solvent.

11. The rechargeable lithium battery of claim 5, wherein the electrolyte comprises a carbonate-based solvent.

12. The rechargeable lithium battery of claim 5, wherein the electrolyte comprises a lithium salt of from about 0.1 M to about 2.0M.

13. The rechargeable lithium battery of claim 5, wherein the separator has an air permeability of from about 170 sec/100 cc to about 380 sec/100 cc.

14. The rechargeable lithium battery of claim 5, wherein the separator has a single layer, double layer or triple layer comprising at least one of polyethylene, polypropylene, polyvinylidene fluoride, polyethylene/polypropylene, and polyethylene/polypropylene/polyethylene, polypropylene/polyethylene/polypropylene.
